(19) United States
(12) Patent Application Publication
(10) Pub. No.: US 2013/0294334 A1
(43) Pub. Date: Nov. 7, 2013

(54) APPARATUS AND METHOD FOR CONTROLLING TRANSMISSION POWER OF A MOBILE STATION

(71) Applicant: FUJITSU LIMITED, Kawasaki-shi (JP)

(72) Inventor: Masaru KABASHIMA, Kawasaki (JP)

(21) Appl. No.: 13/852,541

(22) Filed: Mar. 28, 2013

(30) Foreign Application Priority Data
May 2, 2012 (JP) 2012-105343

(51) Int. Cl. H04W 52/22

(52) U.S. Cl. CPC H04W 52/221
USPC 370/328

(57) ABSTRACT

A base station holds an accumulated value of a transmission-power control command that is transmitted to a mobile station so as to perform closed-loop control of transmission power of the mobile station. The base station detects a discrepancy between an accumulated value held by the base station and an accumulated value of the transmission-power control command held by the mobile station. The base station sets the accumulated value held by the base station and the accumulated value held by the mobile station at the same value when the discrepancy is detected.

### CROSS-REFERENCE TO RELATED APPLICATION

This application is based upon and claims the benefit of priority of the prior Japanese Patent Application No. 2012-105343, filed on May 2, 2012, the entire contents of which are incorporated herein by reference.

### FIELD

The embodiments discussed herein are related to a base station apparatus and method for controlling transmission power of a mobile station.

### BACKGROUND

In mobile communications, a base station apparatus performs closed-loop control on transmission power of a mobile station apparatus using a transmission power control (TPC) command. The mobile station apparatus holds an accumulated correction value of the TPC command, that is, the number of times the TPC command has been received, and uses the accumulated value for determining transmission power. At the same time, the base station apparatus also holds an accumulated value of the TPC command, and uses the accumulated correction value in order to calculate a path loss between the base station apparatus and the mobile station apparatus.

On transmission power control of a mobile station apparatus, it is known that after a random access procedure, an accumulated correction value of the TPC command that is held by the radio base station and the accumulated correction value of the TPC command that is held by the mobile station are matched.

As another related technique, a transmission output circuit provided with a mode of performing closed-loop transmission power control and a mode of performing open-loop transmission power control is known. In the transmission output circuit, transmission power control data from a transmission side is disregarded when the detected signal data is determined to be in a range of a maximum transmission-power specified value, or when the detected signal data is determined to be in a range of a minimum transmission-power specified value.

According to another related technique, there is provided a communication system including a communication terminal apparatus and a base station apparatus. The communication terminal apparatus includes a transmission power setting mechanism that sets transmission power of a predetermined channel, on the basis of a TPC command included in a reception signal and transmission-power setting information which is information for setting transmission power in a predetermined slot before and after a slot in which transmission is temporarily stopped. The mobile terminal apparatus includes a transmission power reporting mechanism that reports a report value of the transmission power on the basis of transmission power in a predetermined section excluding a slot for temporarily stopping transmission which is set by the transmission-power setting mechanism. The base station apparatus includes a scheduling mechanism which makes a schedule of transmission from the mobile terminal apparatus to the base station apparatus on the basis of the reception mechanism receiving a report value from the communication terminal apparatus, and the received report value.

Related-art techniques have been disclosed in Japanese Laid-open Patent Publication Nos. 2011-61706, 2007-189736, and 2010-16852.

### SUMMARY

According to an aspect of the invention, there is provided an apparatus for controlling transmission power of a mobile station. The apparatus holds a first accumulated value of a transmission-power control command that is transmitted to the mobile station so as to perform closed-loop control of transmission power of the mobile station. The apparatus detects a discrepancy between the first accumulated value held by the apparatus and a second accumulated value of the transmission-power control command held by the mobile station, and the apparatus sets both the first accumulated value held by the apparatus and the second accumulated value held by the mobile station at the same value when the discrepancy is detected.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of a communication system, according to an embodiment;

FIG. 2 is a diagram illustrating an example of a hardware configuration of a base station, according to an embodiment;

FIG. 3 is a diagram illustrating an example of a hardware configuration of a mobile station, according to an embodiment;

FIG. 4 is a diagram illustrating an example of a functional configuration of a base station, according to an embodiment;

FIG. 5 is a diagram illustrating an example of a functional configuration of a mobile station, according to an embodiment;

FIG. 6 is a diagram illustrating an example of an operational flowchart of a base station, according to a first embodiment;

FIG. 7 is a diagram illustrating an example of an operational sequence between a base station and a mobile station, according to a first embodiment;

FIG. 8 is a schematic diagram illustrating an example of transition of accumulated values of a transmission power control (TPC) command in association with change in a path loss, according to a first embodiment;

FIG. 9 is a schematic diagram illustrating an example of transition of accumulated values of a TPC command in association with change in a path loss, according to a first embodiment;

FIG. 10 is a diagram illustrating an example of an operational sequence between a base station and a mobile station, according to a second embodiment;

FIG. 11 is a diagram illustrating an example of an operational flowchart of a base station, according to a second embodiment;

FIG. 12 is a schematic diagram illustrating an example of transition of reception intensity in association with change in a path loss, according to a second embodiment; and

FIG. 13 is a diagram illustrating an example of an operational sequence between a base station and a mobile station, according to a third embodiment.

### DESCRIPTION OF EMBODIMENTS

A discrepancy sometimes occurs between the accumulated correction value of the TPC command held by the base station apparatus and the accumulated correction value of the TPC command held by the mobile station apparatus. The discrepancy may occur, for example, when the mobile station apparatus located at a cell edge fails to receive a TPC command, etc. When a discrepancy occurs between the accumulated correction values of the TPC command of the base station apparatus and the mobile station apparatus, an error arises in the path loss calculated by the base station apparatus. An error in the path loss causes an error in the value of the TPC command calculated by closed-loop control of transmission power of the mobile station apparatus. Accordingly, when time passes with a large error remaining, a problem occurs; for example, the power consumption of the mobile station apparatus is expedited.

1. Hardware Configuration

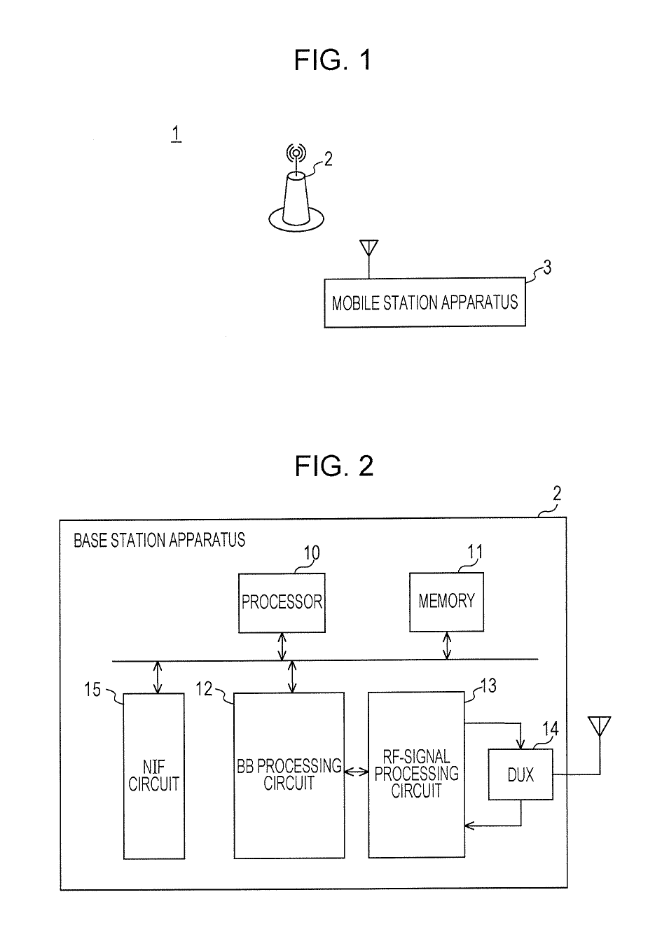

In the following, descriptions will be given of preferable embodiments with reference to the accompanying drawings. FIG. 1 is a diagram illustrating an example of an overall configuration of a communication system. The communication system 1 includes a base station apparatus 2 and a mobile station apparatus 3. The communication system 1 may be a mobile communication system of a long term evolution (LTE) method, which is studied by third generation partnership project (3GPP), for example. In the following descriptions, an example of a mobile communication system of an LTE method according to the embodiments will be described. However, an apparatus and method disclosed in this specification may also be applied to a mobile communication system of the other methods as long as the mobile communication system is a mobile communication system in which transmission power control of a mobile station apparatus is carried out using a path loss calculated by the base station apparatus 3 on the basis of an accumulated correction value of a TPC command. Hereinafter, “accumulated correction value” will be also simply expressed as “accumulated value” for ease of explanation. Further, in the following description, a mobile station apparatus and a base station apparatus are sometimes denoted simply by a “mobile station” and a “base station”, respectively.

1.1. Hardware Configuration of Base Station

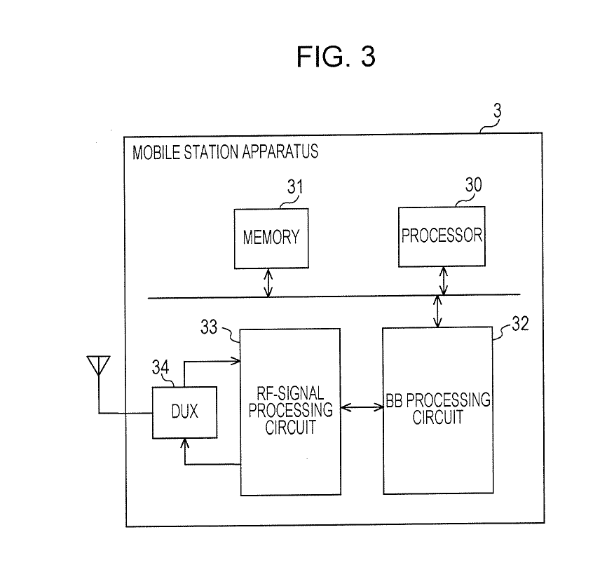

Next, a description will be given of a hardware configuration of the base station 2 with reference to FIG. 2. The base station 2 includes, for example, a processor 10, a memory 11, a baseband processing circuit 12, a radio-frequency signal processing circuit 13, a duplexer 14, and a network interface circuit 15. In this regard, in the following descriptions and the accompanying drawings, a baseband, a radio frequency, a duplexer, and a network interface will be also denoted by “BB”, “RF”, “DUX”, and “NIP”, respectively.

The processor 10 performs operational control of the base station 2 and user management processing other than processing performed by the BB processing circuit 12 which will be described below. The memory 11 stores a control programs for BB signal processing performed by the processor 10. Also, each data and temporary data to be used during the execution of these programs are stored in the memory 11.

The BB processing circuit 12 performs encoding and modulation, and demodulation and decoding of signals transmitted and received between the mobile station 3 and the base station 2, communication protocol processing, and BB signal processing on scheduling. The BB processing circuit 12 may be configured to include a processor for signal processing and a memory for storing programs and data used for operation of the processor. The processor may be a digital signal processor (DSP), or a central processing unit (CPU), for example. Also, the BB processing circuit 12 may include a logical circuit, such as a large scale integration (LSI), an application specific integrated circuit (ASIC), and a field-programming gate array (FPGA), for signal processing.

The RF signal processing circuit 13 performs digital/analog conversion, analog/digital conversion, frequency conversion, signal amplification, and filtering of a radio signal transmitted and received between the mobile station 3 and the base station 2 through the DUX 14. The NIF circuit 15 performs signal processing for transmission and reception of a signal to and from the other base stations and a host apparatus, through a fixed line network.

1.2 Hardware Configuration of Mobile Station

Next, a description will be given of an example of a hardware configuration of the mobile station 3 with reference to FIG. 3. The mobile station 3 may be configured to include a processor 30, a memory 31, a BB processing circuit 32, an RF signal processing circuit 33, and a DUX 34. The processor 30 performs application programs for processing user data. The memory 31 stores the application programs for information processing by the processor 30. Also, each data and temporary data to be used during the execution of these programs are stored in the memory 31.

The BB processing circuit 32 performs encoding and modulation, and demodulation and decoding, of signals transmitted and received between the mobile station 3 and the base station 2, communication protocol processing, and BB signal processing on control of communication processing by the mobile station 3. The BB processing circuit 32 may include a processor for signal processing and a memory for storing programs and data used for operation of the processor. The processor may be a DSP, and a CPU, for example. Also, the BB processing circuit 32 may include a logical circuit, such as an LSI, an ASIC, and an FPGA, for signal processing.

The RF signal processing circuit 33 performs digital/analog conversion, analog/digital conversion, frequency conversion, signal amplification, and filtering, of a radio signal transmitted and received between the mobile station 3 and the base station 2 through the DUX 14.

In this regard, the hardware configurations illustrated in FIG. 2 and FIG. 3 are only examples for describing the embodiment. In the following, the communication system described in this specification may employ any other hardware configuration as long as the operation described below is performed.

2. First Embodiment

2.1. Functional Configuration of Base Station

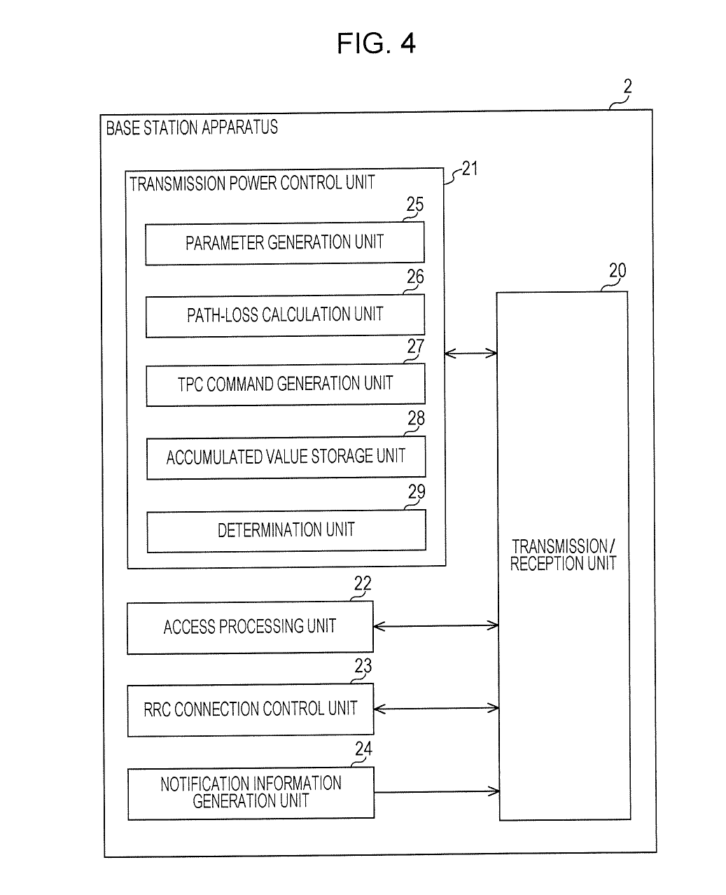

Next, a description will be given of functions achieved by the above-described hardware configuration. FIG. 4 is a diagram illustrating an example of a functional configuration of the base station 2. The base station 2 includes a transmission/reception unit 20, a transmission power control unit 21, an access processing unit 22, a radio-resource control connection control unit 23, and a notification information generation unit 24. In the following description and the accompanying drawings, radio resource control is sometimes denoted by an “RRC.”

The transmission/reception unit 20 performs transmission/reception processing, encoding processing, decoding processing, modulation processing, and demodulation processing, on a control signal and a radio signal of user traffic transmitted and received between the base station 2 and the mobile station 3. The transmission power control unit 21 controls transmission power of the mobile station 3. A description will be further given of the transmission power control unit 21 later.

The access processing unit 22 performs processing at the base station 2 in a random access procedure between the base station 2 and the mobile station 3. The RRC connection control unit 23 performs processing at the base station 2 in an RRC connection and an RRC disconnection by transmitting and receiving an RRC protocol message to and from the mobile station 3 through the transmission/reception unit 20. The notification information generation unit 24 generates notification information including system information, and transmits the generated notification information to the mobile station 3 through the transmission/reception unit 20.

The transmission power control unit 21 performs closed-loop control of transmission power of the mobile station 3 on the basis of the difference between a target signal-to-interference and noise power ratio (SINR) that is determined based on the a path loss between the base station 2 and the mobile station 3, and a reception signal SINR. Also, the mobile station 3 performs open loop control of transmission power of the mobile station 3. The transmission power control unit 21 transmits parameters to be used for open loop control to the mobile station 3 through the transmission/reception unit 20.

For this reason, the transmission power control unit 21 is configured to include a parameter generation unit 25, a path-loss calculation unit 26, a TPC-command generation unit 27, an accumulated value storage unit 28, and a determination unit 29. The parameter generation unit 25 generates parameters to be used for open loop control by the mobile station 3. In the open loop control, the mobile station 3 calculates a transmission power P_{PUSCH} by the following expression (1).

P_{PUSCH}=min{P_{CMAX}, 10×log₁₀(M_{PUSCH})+P_{OPUSCH}+α×PL+Δ_{TF}+f(i)} (1)

Here, P_{CMAX} is a maximum transmission power, M_{PUSCH} is a transmission bandwidth, P_{OPUSCH} is a target reception power, and α is a weighting factor of a fractional TPC. PL is a path loss measured by the mobile station 3, Δ_{TF} is an offset which depends on modulation and coding scheme (MCS), f(i) is an accumulated value of the PTC command. The parameter generation unit 25 generates parameters, such as the target reception power P_{OPUSCH} and the weighting factor α, and transmits the generated parameters to the mobile station 3 through the transmission/reception unit 20.

The path-loss calculation unit 26 calculates a path loss PL between the base station 2 and the mobile station 3 using the following expression (2), based on the an uplink power headroom (UPH) transmitted from the mobile station 3.

PL=(P_{CMAX}−UPH−10×log₁₀(M_{PUSCH})−P_{OPUSCH}−Δ_{TF}−f(i))/α (2)

, where UPH is the difference between the maximum transmission power P_{CMAX} and the transmission power _{PPUSCH} of the mobile station 3, and is calculated by the mobile station 3.

The TPC-command generation unit 27 calculates the target SINR, based on the path loss obtained by the path-loss calculation unit 26. The TPC-command generation unit 27 determines a first TPC command on the basis of the difference between the target SINR and the reception signal SINR from the mobile station 3. A first TPC command designates a relative value which specifies an amount of change of the current transmission power of the mobile station 3 to the target power. The first TPC command, for example, designates Accumulated δ to be used in LTE.

Accumulated δ is transmitted with being stored in DCI format 0, 3 or 3A, which is downlink control information (DCI). TPC command values “0”, “1”, “2” and “3”, which are stored in the DCI formats, designate Accumulated δ of values “−1 dB”, “0 dB”, “1 dB” and “3 dB”, respectively.

The TPC-command generation unit 27 transmits the first TPC command to the mobile station 3 through the transmission/reception unit 20, and stores the accumulated value f(i) of the transmitted first TPC command into the accumulated value storage unit 28. In the following description, the accumulated value of the first TPC command is sometimes denoted simply by an “accumulated value”.

The determination unit 29 determines whether or not a discrepancy occurs between an accumulated value f(i) held by the base station 2 and an accumulated value f(i) held by the mobile station 3. For example, the determination unit 29 determines that a discrepancy occurs between the accumulated values f(i) held by the base station 2 and the mobile station 3, when the accumulated value f(i) stored in the accumulated value storage unit 28 is higher than an upper-limit threshold value Th1, or lower than a lower-limit threshold value Th2. In such a case, it is conceivable that a mobile station 3 located at a cell edge has failed to receive a TPC command, and thus the base station 2 has continued to send a TPC command for increasing transmission power, or has continued to send a TPC command for decreasing transmission power.

When it is determined that a discrepancy has occurred between the accumulated values f(i) held by the base station 2 and by the mobile station 3, the TPC-command generation unit 27 generates a second TPC command which sets the accumulated value f(i) of the mobile station 3 at a specified value. An example of the second TPC command is Absolute δ to be used in LTE. Absolute δ is transmitted with being stored in the DCI format 0. TPC command values “0”, “1”, “2” and “3”, which are stored in the DCI formats, designate Absolute δ of values “31 4 dB”, “−1 dB”, “1dB”, and “4 dB”, respectively.

The TPC-command generation unit 27 transmits the second TPC command to the mobile station 3 through the transmission/reception unit 20, and sets the value of the accumulated value f(i) stored in the accumulated value storage unit 28 at the value indicated by the second TPC command. As a result, the accumulated value f(i) held by the mobile station 3 matches the accumulated value f(i) held by the base station 2. When the accumulated values f(i) match, the accumulated value f(i) to be used for calculating the path loss in the expression (2) by the base station 2 matches the accumulated value f(i) used by the mobile station 3 for calculating UPH used for calculating the path loss, and thus an error of the path loss caused by mismatch of the accumulated values f(i) is resolved.

In a time period in which a path loss between the base station 2 and the mobile station 3 is large, even if the second TPC command is transmitted, the mobile station 3 might fail in receiving the second TPC command. Accordingly, the TPC-command generation unit 27 may be configured to monitor the path loss obtained by the path-loss calculation unit 26, and to transmit the second TPC command when the path loss becomes less than a predetermined threshold value Th3.

In the following description, as examples of the first TPC command and the second TPC command, Accumulated δ and Absolute δ are used, respectively. However, these examples do not intend that the communication system described in the embodiments is limitedly applied to a system using the TPC commands Accumulated δ and Absolute δ.

The above-described operation of the transmission/reception unit 20 is performed by the collaboration of the processor 10 and the RF signal processing circuit 13, which are illustrated in FIG. 2. The above-described operation of the transmission power control unit 21 is performed by the BB processing circuit 12. The above-described operations of the access processing unit 22, the RRC connection control unit 23, and the notification information generation unit 24 may be performed by the processor 10. The storage area of the accumulated value storage unit 28 may be acquired in the memory 11, or may be acquired in the BB processing circuit 12.

2.2. Functional Configuration of Mobile Station

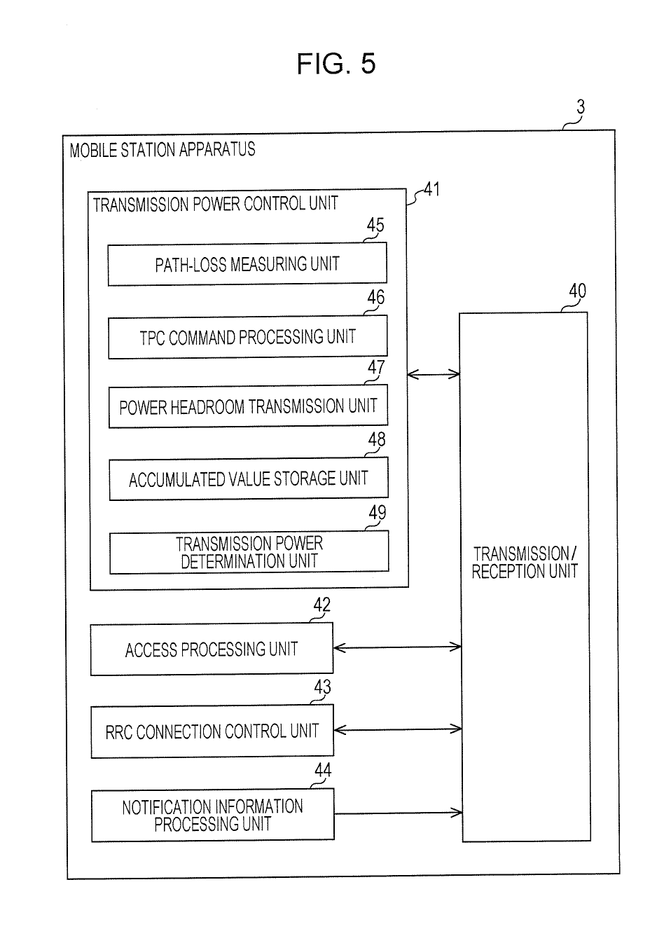

FIG. 5 is a diagram illustrating an example of a functional configuration of the mobile station 3. The mobile station 3 includes a transmission/reception unit 40, a transmission power control unit 41, an access processing unit 42, an RRC connection control unit 43, and a notification information processing unit 44. The transmission/reception unit 40 performs transmission/reception processing, encoding processing, decoding processing, modulation processing, and demodulation processing, on a control signal and a radio signal of user traffic transmitted and received between the base station 2 and the mobile station 3. The transmission power control unit 41 controls transmission power of the mobile station 3. A description will be further given of the transmission power control unit 41 later.

The access processing unit 42 performs processing at the mobile station 3 in a random access procedure between the base station 2 and the mobile station 3. The RRC connection control unit 43 transmits and receives an RRC protocol message to and from the base station 2 through the transmission/reception unit 40, and performs processing at the mobile station 3 in an RRC connection and an RRC disconnection. The notification information processing unit 44 receives notification information transmitted from the base station 2 through the transmission/reception unit 40, and sets the operation of the mobile station 3 in accordance with system information included in the notification information.

The transmission power control unit 41 performs closed-loop control of transmission power of the mobile station 3 on the basis of the TPC command transmitted from the base station 2 and open loop control of transmission power of the mobile station 3 on the basis of the reception power of the reference signal received by the base station 2. The transmission power control unit 41 includes a path-loss measuring unit 45, a TPC command processing unit 46, a power headroom transmission unit 47, an accumulated value storage unit 48, and a transmission power determination unit 49.

The path-loss measuring unit 45 measures a path loss between the base station 2 and the mobile station 3 on the basis of a reception power of the downlink reference signal. When Accumulated δ is received, the TPC command processing unit 46 adds the amount of change of the transmission power indicated by Accumulated δ to the accumulated value f(i) stored in the accumulated value storage unit 48. When Absolute δ is received, the TPC command processing unit 46 changes the value of the accumulated value f(i) stored in the accumulated value storage unit 48 to the value of the transmission power indicated by Absolute δ.

The power headroom transmission unit 47 calculates the transmission power P_{PUSCH} of the above-described expression (1) on the basis of the parameter received from the base station 2 and the path loss measured by the path-loss measuring unit 45, and calculates the difference between the maximum transmission power P_{CMAX}(and the transmission power _{PPUSCH} as UPH. The power headroom transmission unit 47 transmits the calculated UPH to the base station 2 through the transmission/reception unit 40.

The transmission power determination unit 49 performs open loop control of transmission power of the transmission/reception unit 40 in a relatively long cycle. In the open loop control, the transmission power determination unit 49 determines the transmission power P_{PUSCH} in the above-described expression (1) on the basis of the parameter received from the base station 2 and the path loss measured by the path-loss measuring unit 45.

When a TPC command is received during a cycle of the open loop control, the transmission power determination unit 49 performs closed-loop control of transmission power of the transmission/reception unit 40. That is to say, when Accumulated δ is received, the transmission power determination unit 49 changes the transmission power of the transmission/reception unit 40 in accordance with the value of Accumulated δ. When Absolute δ is received, the transmission power determination unit 49 determines the transmission power P_{PUSCH} in the above-described expression (1) using the f(i) specified by Absolute δ.

The above-described operation of the transmission/reception unit 40 is performed by the collaboration of the processor 30 and the RF signal processing circuit 33, which are illustrated in FIG. 3. The above-described operation of the transmission power control unit 41 is performed by the BB processing circuit 32. The above-described operation of the access processing unit 42, the RRC connection control unit 43, and the notification information processing unit 44 are performed by the processor 30. The storage area of the accumulated value storage unit 48 may be acquired in the memory 31, or may be acquired in the BB processing circuit 32.

Also, the functional configuration diagrams in FIG. 4 and FIG. 5 are illustrated centrally on the configuration related to the functions of the base station 2 and the mobile station 3, which are described in the present specification. The base station 2 and the mobile station 3 may include components other than the components illustrated in the drawings.

2.3. Operation of Base Station

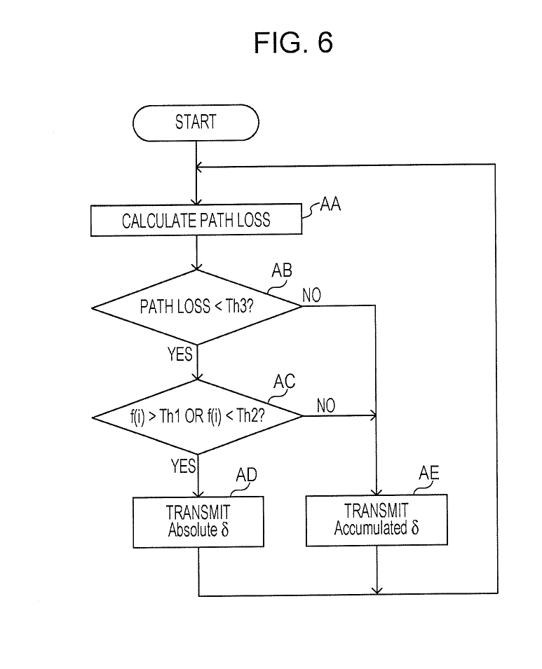

Next, a description will be given of the operation of the base station 2 with reference to FIG. 6. A series of operation described with reference to FIG. 6 may be interpreted as a method including a plurality of procedures. In operation AA, the path-loss calculation unit 26 calculates the path loss between the base station 2 and the mobile station 3 on the basis of the UPH transmitted from the mobile station 3.

In operation AB, the TPC-command generation unit 27 determines whether or not the path loss is less than the threshold value Th3. When the path loss is less than the threshold value Th3 (operation AB: YES), the processing proceeds to operation AC. When the path loss is not less than the threshold value Th3 (operation AB: NO), the processing proceeds to operation AE.

In operation AC, the determination unit 29 determines whether the accumulated value f(i) is higher than the upper-limit threshold value Th1, or lower than the lower-limit threshold value Th2. When the accumulated value f(i) is higher than the upper-limit threshold value Th1, or lower than the lower-limit threshold value Th2 (operation AC: YES), the processing proceeds to operation AD. When the accumulated value f(i) is lower than the upper-limit threshold value Th1 and not lower than the lower-limit threshold value Th2 (operation AC: NO), the processing proceeds to operation AE.

In operation AD, the TPC-command generation unit 27 transmits Absolute δ to the mobile station 3. After that, the processing returns to operation AA. In operation AE, the TPC-command generation unit 27 transmits Accumulated δ to the mobile station 3. After that, the processing returns to operation AA.

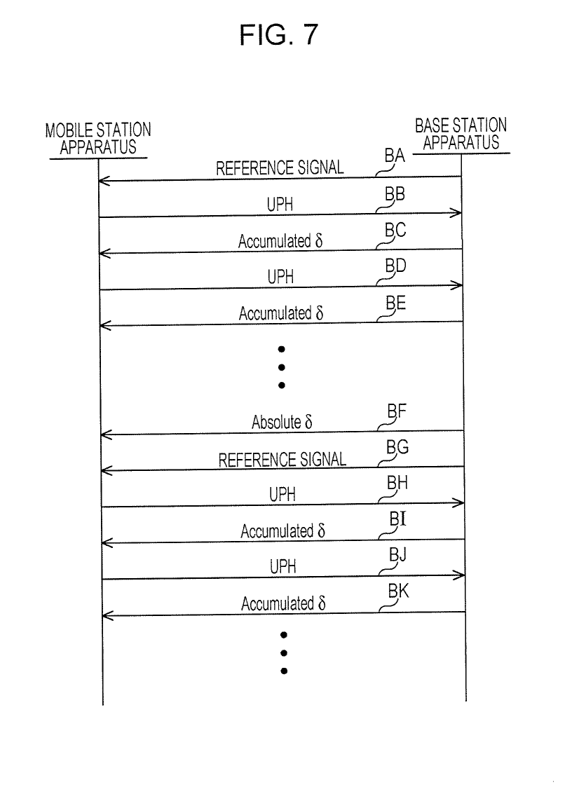

FIG. 7 illustrates an example of a signal sequence between the base station 2 and the mobile station 3, which arises by the above-described operation. In operations BA to BE, closed-loop control of transmission power of the mobile station 3 is performed. In operation BA, a downlink reference signal (RS) is transmitted from the base station 2 to the mobile station 3. In operation BB, the mobile station 3 calculates UPH in accordance with the path loss measured on the basis of the link reference signal RS, and transmits the calculated UPH to the base station 2. In operation BC, the base station 2 determines Accumulated δ in accordance with the path loss calculated on the basis of the UPH, and transmits the Accumulated δ to the mobile station 3.

In the same manner, in operations BD and BE, the mobile station 3 transmits the UPH to the base station 2, and the base station 2 transmits the Accumulated δ to the mobile station 3. By the transmission of Accumulated δ, the values of TPC commands are accumulated in the accumulated value f(i) in the base station 2 and the mobile station 3.

When the determination unit 29 detects a discrepancy between the accumulated values f(i) held by the base station 2 and the mobile station 3, respectively, in operation BF, the base station 2 transmits Absolute δ to the mobile station 3. By the transmission of Absolute δ, accumulated values f(i) held by the base station 2 and the mobile station 3, respectively, become the same. As a result, an error in the path loss calculation by the base station 2 is resolved. After that, in operations BG to BK, in the same manner as in the above-described operations BA to BE, closed-loop control of transmission power of the mobile station 3 is performed.

2.4. Advantage of Embodiment

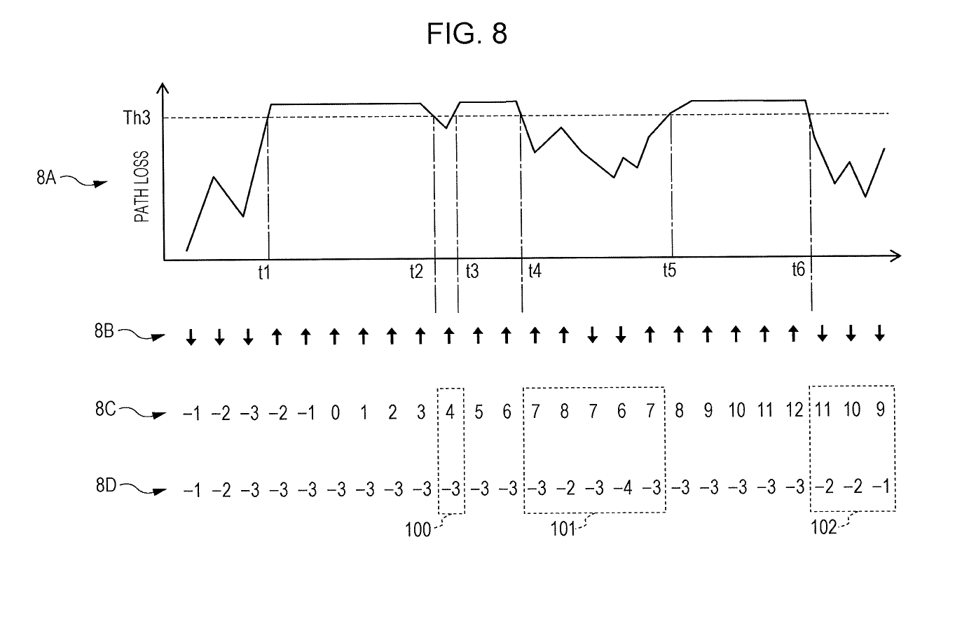

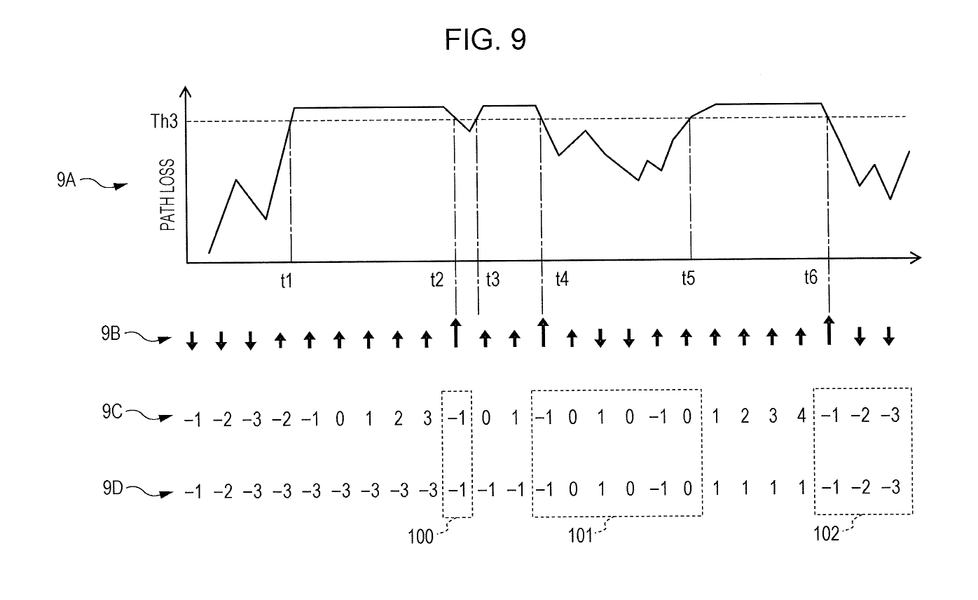

According to the embodiment, a time period until the accumulated values f(i) held by the base station 2 and the mobile station 3, respectively, match becomes short. As a result, a time period needed for correcting a path loss error calculated by the base station 2 is shortened. A description will be given of this state with reference to 8A to 8D in FIGS. 8 and 9A to 9D in FIG. 9.

8A in FIGS. 8 and 9A in FIG. 9 illustrate a time change in the path loss between the base station 2 and the mobile station 3. During a time period t1 to t2, the path loss exceeds the threshold value Th3. In the same manner, during a time periods t3 to t4, and t5 to t6, the path loss exceeds the threshold value Th3.

8B in FIGS. 8 and 9B in FIG. 9 are schematic diagrams of the TCP commands transmitted from the base station 2 to the mobile station 3. A down arrow indicates Accumulated δ which instructs to decrease transmission power by 1 dB. A relatively short up arrow indicates Accumulated δ which instructs to increase transmission power by 1 dB. A relatively long up arrow indicates Absolute δ which instructs to set transmission power to −1 dB. 8B in FIG. 8 is an example of TCP commands in which a discrepancy of the accumulated values f(i) is not resolved using Absolute δ. 9B in FIG. 9 is an example of TCP commands in which a discrepancy of the accumulated values f(i) is resolved using Absolute δ.

8C in FIGS. 8 and 9C in FIG. 9 illustrate the accumulated value f(i) held by the base station 2, and 8D in FIGS. 8 and 9D in FIG. 9 illustrate the accumulated value f(i) held by the mobile station 3. In a time period from t1 to t2, in which the path loss exceeds the threshold value Th3, the mobile station 3 fails to receive a TCP command, and thus the difference between the accumulated values f(i) of the base station 2 and the mobile station 3 expands from “(−3)−(−3)=0” to “3−(−3)=6”. In time periods from t3 to t4 and from t5 to t6, in which the path loss exceeds the threshold value Th3, the difference between the accumulated values f(i) of the base station 2 and the mobile station 3 expands in the same manner.

As illustrated in 8B in FIG. 8, in the case of not using Absolute δ, when the discrepancy of accumulated values f(i) arises, in a time period 100 from time t2 to time t3, even if the path loss becomes less than the threshold value Th3, the discrepancy of the accumulated values f(i) is not resolved. This is the same for a time period 101 from time t4 to time t5 and a time period 102 from the time t6 and thereafter, in which the path loss becomes less than the threshold value Th3.

On the other hand, as illustrated in 9B in FIG. 9, in the base station 2 according to the embodiment, when the determination unit 29 detects a discrepancy of the accumulated values f(i), the base station 2 transmits Absolute δ at timing time t2, t4, and t6 when the path loss becomes less than the threshold value Th3. Accordingly, in the example illustrated in 9C and 9D in FIG. 9, the accumulated values f(i) of the base station 2 and the mobile station 3 match in time periods 100, 101, and 102. In this manner, according to the embodiment, it is understood that a discrepancy of the accumulated values f(i) between the base station 2 and the mobile station 3 is resolved quickly using Absolute δ.

2.5. Variation

In the following, a description will be given of a variation of the embodiment. A determination unit 29 may be configured to determine that a discrepancy of the accumulated values f(i) held by the base station 2 and the mobile station 3 occurs, in place of or in addition to the above-described determination, when a first TPC command which increases transmission power has been issued consecutively for a predetermined threshold number of times. It is also possible to configure a determination unit 29 so as to determine that a discrepancy of the accumulated values f(i) held by the base station 2 and the mobile station 3 occurs, in place of or in addition to the above-described determination, when a first TPC command which decreases transmission power has been issued consecutively for a predetermined threshold number of times.

Also, it is possible, in place of transmitting Absolute δ, to release the synchronization between the base station 2 and the mobile station 3 and carry out random access when a discrepancy of the accumulated values f(i) held by the base station 2 and the mobile station 3 occurs. Carrying out random access allows the accumulated values f(i) held by the base station 2 and the mobile station 3 to be reset and identical with each other.

For this purpose, when the determination unit 29 of the base station 2 detects a discrepancy of the accumulated values f(i) held by the base station 2 and the mobile station 3, respectively, the access processing unit 22 transmits a synchronization request Sync Request to the mobile station 3 through the transmission/reception unit 20. Sync Request is an instruction signal which causes the mobile station 3 to start a random access procedure.

When the mobile station 3 receives Sync Request, the access processing unit 42 of the mobile station 3 starts the random access procedure. The access processing unit 42 transmits a random access preamble to the base station 2. When the base station 2 receives the random access preamble, the access processing unit 22 of the base station 2 transmits a random access response to the mobile station 3. When the mobile station 3 receives the random access response, the access processing unit 42 of the mobile station 3 transmits a MAC control element (CE) of media access control (MAC) to the base station 2. This MAC CE includes a cell-radio network temporary identifier (C-RNTI) obtained by the mobile station 3 before the mobile station 3 starts the random access procedure.

When the base station 2 receives the MAC CE and identifies the mobile station 3, the RRC connection control unit 23 of the base station 2 starts RRC connection processing. At this time, the value of the accumulated value f(i) stored in the accumulated value storage unit 28 of the base station 2 is reset to “0”. The RRC connection control unit 23 performs reconfiguration related to RRC connection with the mobile station 3, by transmitting RRC Connect Reconfiguration, which is a RRC protocol message, to the mobile station 3 and receiving RRC Reconfiguration Complete from the mobile station 3.

Upon receiving RRC Connect Reconfiguration from the base station 2, the RRC connection control unit 43 of the mobile station 3 performs reconfiguration related to RRC connection with the base station 2. When the mobile station 3 receives RRC Connect Reconfiguration, the value of the accumulated value f(i) stored in the accumulated value storage unit 48 of the mobile station 3 is reset to “0”. As a result, by the above-described procedure, both the accumulated values f(i) held by the base station 2 and the mobile station 3 are reset to “0”, and thus the both values match. When the reconfiguration processing of RRC connection is complete, the RRC connection control unit 43 transmits RRC Reconfiguration Complete to the base station 2.

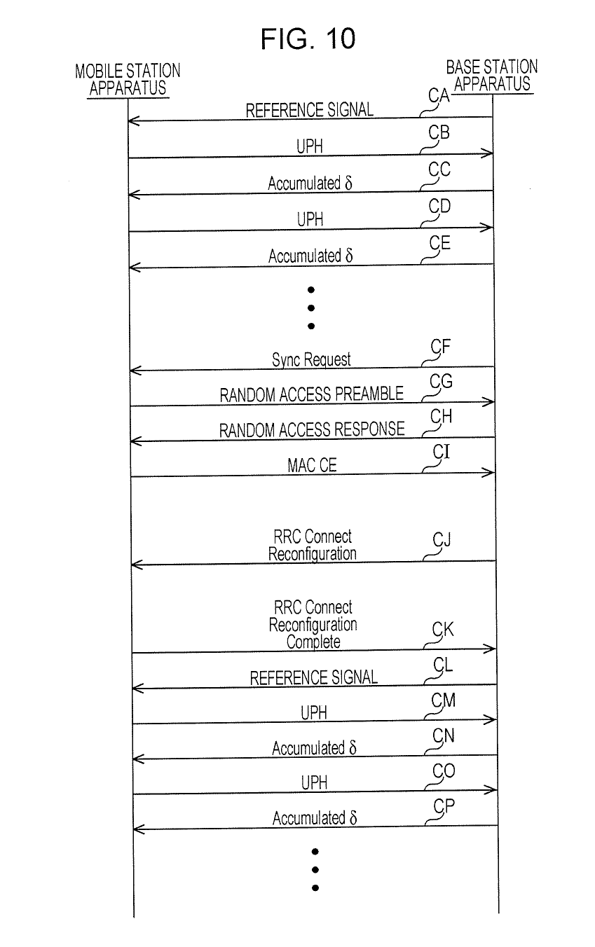

FIG. 10 illustrates an example of a signal sequence between the base station 2 and the mobile station 3 when random access is performed between the base station 2 and the mobile station 3 at the time when a discrepancy of the accumulated values f(i) held by the base station 2 and the mobile station 3 occurs. In operations CA to CE, closed-loop control of transmission power of the mobile station 3 is performed in the same manner as operations BA to BE in FIG. 7.

When the determination unit 29 detects a discrepancy between the accumulated values f(i) of the base station 2 and the mobile station 3, in operation CF, the base station 2 transmits Sync Request to the mobile station 3. By the transmission of Sync Request, the random access procedure is started, and the synchronization up to that time between the base station 2 and the mobile station 3 is released.

In operation CG, upon receiving Sync Request, the mobile station 3 transmits a random access preamble to the base station 2. In operation CH, upon receiving the random access preamble, the base station 2 transmits a random access response to the mobile station 3. In operation CI, upon receiving the random access response, the mobile station 3 transmits MAC CE to the base station 2.

After that, the base station 2 and the mobile station 3 starts reconfiguration processing of RRC connection. In operation CJ, the base station 2 transmits a RRC Connect Reconfiguration message to the mobile station 3. At this time, the value of the accumulated value f(i) stored in the accumulated value storage unit 28 of the base station 2 is set at “0”.

When the mobile station 3 receives a RRC Connect Reconfiguration message, the value of the accumulated value f(i) stored in the accumulated value storage unit 48 of the mobile station 3 is reset to “0”. As a result, both the accumulated values f(i) held by the base station 2 and the mobile station 3 are reset to “0”, and thus the both values match. In operation CK, the mobile station 3 transmits a RRC Connect Reconfiguration Complete message to the mobile station 3. After that, in operations CL to CP, closed-loop control of transmission power of the mobile station 3 is performed in the same manner as in the above-described operations CA to CE.

3. Second Embodiment

Next, a description will be given of a communication system 1 according to a second embodiment. The path loss between the base station 2 and the mobile station 3 changes in accordance with movement of the mobile station 3 and a change in a surrounding electromagnetic environment of the mobile station 3. A change in the path loss depends not only on a distance between the base station 2 and the mobile station 3, but also on another factor, for example, an electromagnetic environment such as the visibility between the base station 2 and the mobile station 3. Accordingly, when the electromagnetic environment of the mobile station 3 and the path loss abruptly change because of movement of the mobile station 3, the reception intensity at the base station 2 sometimes changes abruptly.

In this case, when the amount of change is large, it sometimes takes long time until transmission power becomes a proper value by step-by-step adjustment of transmission power using Accumulated δ. In the second embodiment, when the path loss changes abruptly, Absolute δ is transmitted, and the transmission power of the mobile station 3 is changed faster than the adjustment by Accumulated δ.

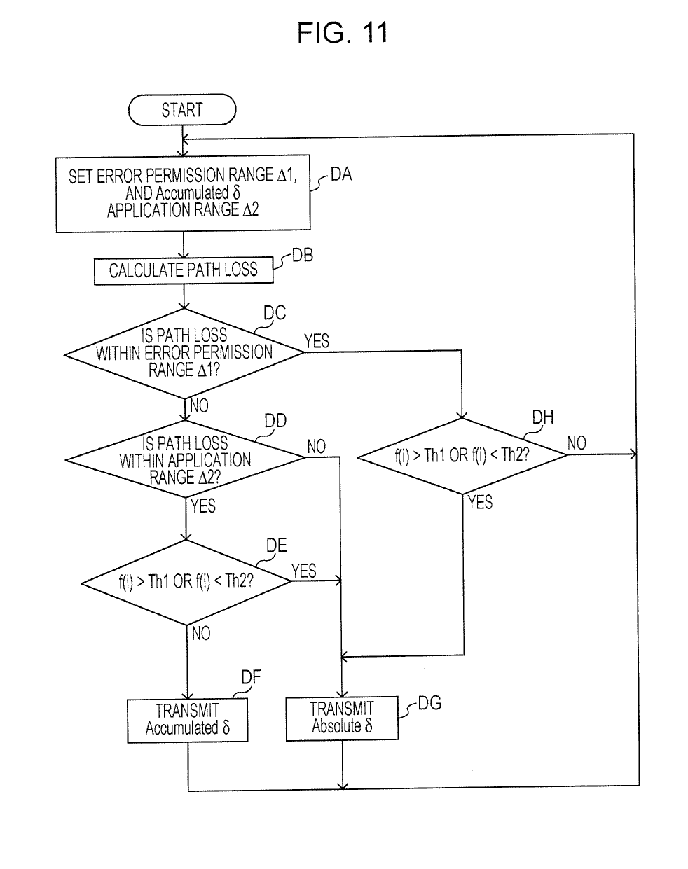

FIG. 11 is an explanatory diagram of a second example of operation of the base station 2. In operation DA, the TPC-command generation unit 27 sets an error permissible range Δ1 and an Accumulated δ application range Δ2. When the path loss calculated by the path-loss calculation unit 26 is within the error permissible range Δ1, the TPC-command generation unit 27 does not transmit a TPC command to the mobile station 3. When the path loss exceeds the error permissible range Δ1, the TPC-command generation unit 27 transmits a TPC command to the mobile station 3.

When the path loss is within the Accumulated δ application range Δ2, the TPC-command generation unit 27 transmits Accumulated δ to the mobile station 3. When the path loss exceeds the Accumulated δ application range Δ2, the TPC-command generation unit 27 transmits Absolute δ to the mobile station 3.

For example, the TPC-command generation unit 27 may set, as a reference value, a path loss that was calculated by the path-loss calculation unit 26 before, for example, the path loss calculated at the previous time and may set an up-and-down range having a predetermined width as an error permissible range Δ1 and an application range Δ2. Also, for example, the TPC-command generation unit 27 may set an up-and-down range having a predetermined width as an error permissible range Δ1 and an application range Δ2, using a moving average of the path losses from a past time point to the current time point as a reference value.

In operation DB, the path-loss calculation unit 26 calculates a path loss. In operation DC, the TPC-command generation unit 27 determines whether the path loss is within the error permissible range Δ1 or not. When the path loss is within the error permissible range Δ1 (operation DC: YES), the processing proceeds to operation DH. When the path loss is not within the error permissible range Δ1 (operation DC: NO), the processing proceeds to operation DD.

In operation DD, the TPC-command generation unit 27 determines whether the path loss is within the Accumulated δ application range Δ2 or not. When the path loss is within the Accumulated δ application range Δ2 (operation DD: YES), the processing proceeds to operation DE. When the path loss is not within the application range Δ2 (operation DD: NO), the processing proceeds to operation DG.

In operation DE, the determination unit 29 determines whether the accumulated value f(i) is higher than the upper-limit threshold value Th1 or lower than the lower-limit threshold value Th2. When the accumulated value f(i) is higher than the upper-limit threshold value Th1 or lower than the lower-limit threshold value Th2 (operation DE: YES), the processing proceeds to operation DG. When the accumulated value f(i) is lower than the upper-limit threshold value Th1, and not lower than the lower-limit threshold value Th2 (operation DE: NO), the processing proceeds to operation DF.

In operation DF, the TPC-command generation unit 27 transmits Accumulated δ to the mobile station 3. After that, the processing returns to operation DA. In operation DG, the TPC-command generation unit 27 transmits Absolute δ to the mobile station 3. After that, the processing returns to operation DA.

In operation DH, the determination unit 29 determines whether the accumulated value f(i) is higher than the upper-limit threshold value Th1 or lower than the lower-limit threshold value Th2. When the accumulated value f(i) is higher than the upper-limit threshold value Th1 or lower than the lower-limit threshold value Th2 (operation DH: YES), the processing proceeds to operation DG. When the accumulated value f(i) is lower than the upper-limit threshold value Th1 and not lower than the lower-limit threshold value Th2 (operation DH: NO), the processing returns to operation DA.

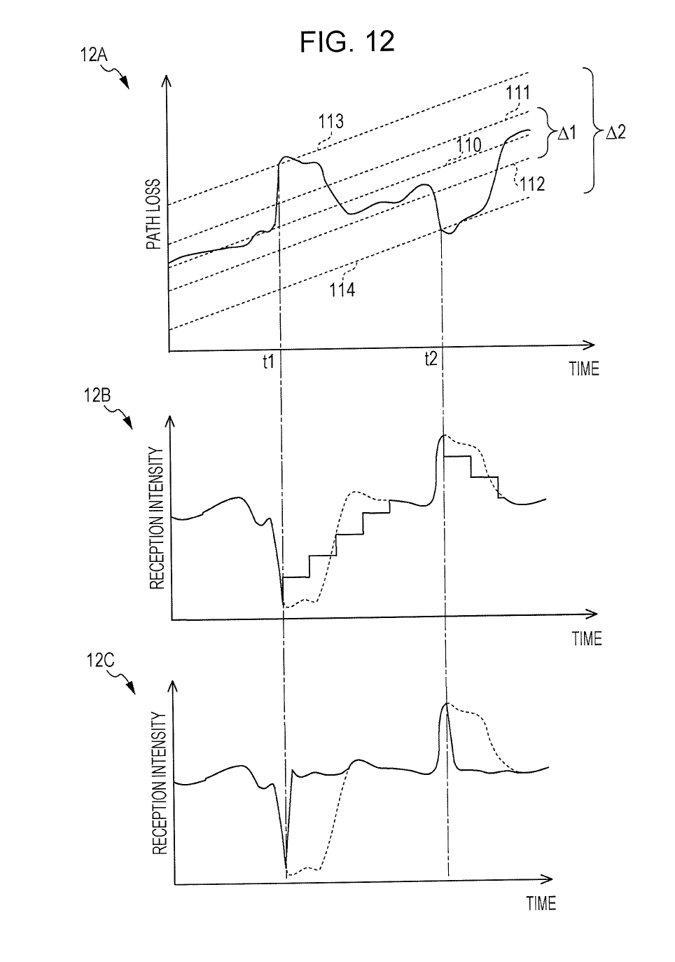

According to the second embodiment, when the path loss abruptly changes, Absolute δ is transmitted to the mobile station 3. When the mobile station 3 receives Absolute δ, a previous accumulated value f(i) is discarded, and a transmission power P_{PUSCH} is determined by the above-described expression (1) on the basis of the accumulated value f(i) specified by Absolute δ and the path loss measured by the mobile station 3. Accordingly, the transmission power is immediately set at a proper value in response to the current path loss. A description will be given of this state with reference to 12A, 12B, and 12C in FIG. 12.

12A in FIG. 12 is a diagram illustrating a second example of a change in path loss. A solid line indicates a change in the path loss, which is caused by a change in radio wave interference surrounding the mobile station 3. A dotted line 110 schematically indicates a reference value of the path loss at the time of setting the error permissible range Δ1 and the application range Δ2. In this example, it is assumed that the moving average of the path losses is used for the reference value of the path loss at the time of setting the error permissible range Δ1 and the application range Δ2. The mobile station 3 is moving farther from the base station 2, and the reference value 110 of the path loss has an increasing tendency with passage of time.

Dotted lines 111 and 112 indicate an upper limit and a lower limit of the error permissible range Δ1, respectively. Dotted lines 113 and 114 indicate an upper limit and a lower limit of the Accumulated δ application range Δ2, respectively. In this example, it is assumed that the path loss abruptly increases at time t1, exceeding the upper limit 113 of the Accumulated δ application range Δ2, and the path loss abruptly decreases at time t2, falling below the lower limit 114 of the Accumulated δ application range Δ2.

12B in FIG. 12 indicates a reception intensity at the base station 2 in the case of not transmitting Absolute δ at time t1 and time t2. When the path loss exceeds the error permissible range Δ1, the base station 2 starts transmission of Accumulated δ. As a result, the reception power, which abruptly decreased at time t1, gradually recovers step by step. In the same manner, the reception power, which has abruptly increased at time t2, gradually recovers step by step.

12C in FIG. 12 indicates a reception intensity at the base station 2 in the case of transmitting Absolute δ at time t1 and time t2. When the path loss exceeds the application range Δ2, the base station 2 transmits Absolute δ. By reception of Absolute δ, the mobile station 3 sets the transmission power at a proper value in accordance with the path loss after the change, and thus the reception power immediately recovers.

When the accumulated value f(i) is lower than the upper-limit threshold value Th1 and not lower than the lower-limit threshold value Th2, even if a discrepancy between the accumulated values f(i) held by the base station 2 and the mobile station 3 occurs, the determination unit 29 does not detect this discrepancy. Further, when the number of consecutive occurrence of Accumulated δ which increases transmission power, and the number of consecutive occurrence of Accumulated δ which decreases transmission power is lower than the threshold value, the determination unit 29 does not detect a discrepancy of the accumulated values f(i).

For example, a discrepancy of the accumulated values f(i) sometimes occurs at the time of setting an uplink radio resource. At the time of setting an uplink radio resource, there is a difference in reset timing of the accumulated values f(i) between the base station 2 and the mobile station 3. Accordingly, when a TPC command is issued during this time period, a discrepancy of the accumulated values f(i) arises between the base station 2 and the mobile station 3. In this case, the base station 2 will neither continue to transmit TPC to increase transmission power nor continue to transmit TPC to decrease transmission power. Accordingly, the determination unit 29 will not detect a discrepancy of the accumulated values f(i) all the time.

For example, when there is no data transmission on a physical uplink shared channel (PUSCH) assigned by uplink (UL) grant signal, only the mobile station 3 accumulates values of TPC commands, and the base station 2 does not accumulate values of TPC commands. As a result, a discrepancy between the accumulated values f(i) of the base station 2 and the mobile station 3 arises. In this case, the accumulated value f(i) of the base station 2 does not change, and thus the determination unit 29 will not detect a discrepancy of the accumulated values f(i) all the time.

According to the embodiments, even if the determination unit 29 does not detect a discrepancy of the accumulated values f(i) in this manner, the discrepancy is resolved with the transmission of Absolute δ as described below.

4. Third Embodiment

Next, a description will be given of a communication system 1 according to a third embodiment. As described above, even if a discrepancy of the accumulated values f(i) held by the base station 2 and the mobile station 3 occurs, a case is conceivable in which the determination unit 29 does not detect the discrepancy. Thus, in the third embodiment, the base station 2 and the mobile station 3 are configured to periodically reset the accumulated values f(i).

The notification information generation unit 24 of the base station 2 transmits, as notification information, timing information indicating timing for the base station 2 and the mobile station 3 to periodically reset the accumulated values f(i), to the mobile station 3. The notification information processing unit 44 of the mobile station 3 obtains the timing information from the received notification information. Both the TPC-command generation unit 27 of the base station 2 and the TPC command processing unit 46 of the mobile station 3 reset the accumulated values f(i) at the time specified by the timing information. For example, the timing information may be configured to specify timing at which the accumulated values f(i) is reset, by using system frame number (SFN). The timing information may be also configured to specify the timing as a time that comes periodically.

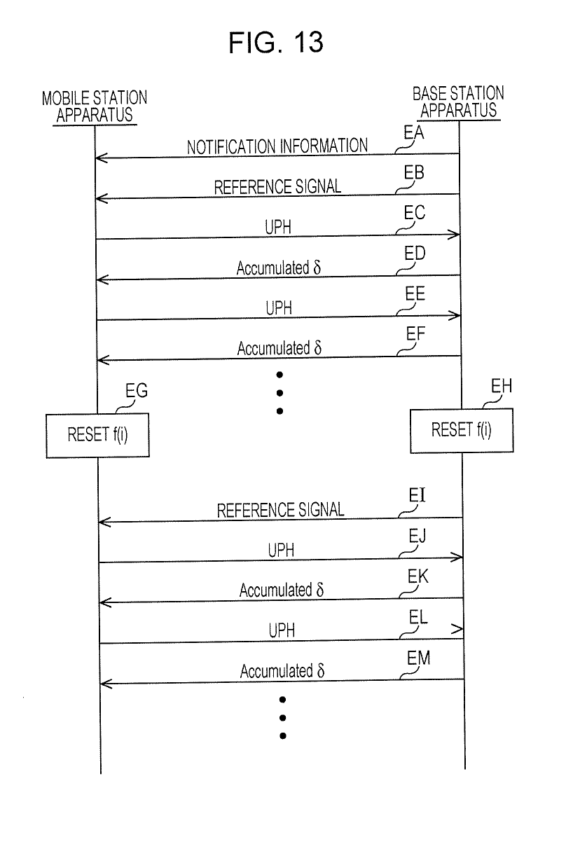

FIG. 13 illustrates an example of a signal sequence between the base station 2 and the mobile station 3 in the case where accumulated values f(i) held by the base station 2 and the mobile station 3 are periodically reset. In operation EA, the base station 2 transmits notification information including system information specifying a radio frame number indicating reset timing of the accumulated values f(i). In operations EB to EF, closed-loop control of transmission power of the mobile station 3 is performed in the same manner as operations BA to BE in FIG. 7.

When transmission time of the radio frame specified by the system information comes, in operations EG and EH, the mobile station 3 and the base station 2 reset the accumulated values f(i) to value “0”. Accordingly, even if a discrepancy of the accumulated values f(i) of the mobile station 3 and the base station 2 has occurred before that time, the accumulated values f(i) match again. After that, in operations EI to EM, closed-loop control of transmission power of the mobile station 3 is performed in the same manner as in the above-described operations EB to EF.

According to the third embodiment, even if the determination unit 29 does not detect a discrepancy of the accumulated values f(i) in this manner, the discrepancy of the accumulated values f(i) is resolved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus for controlling transmission power of a mobile station, the apparatus comprising:
a memory configured to hold a first accumulated value of a transmission-power control command that is transmitted to the mobile station to perform closed-loop control of transmission power of the mobile station;
a processor configured:
to detect a discrepancy between the first accumulated value held by the memory and a second accumulated value of the transmission-power control command held by the mobile station, and
to set both the first accumulated value held by the memory and the second accumulated value held by the mobile station at a same value when the discrepancy is detected.

2. The apparatus of claim 1, wherein
the hardware processor determines that the discrepancy is detected when the first accumulated value stored in the memory exceeds a threshold value.

3. The apparatus of claim 1, wherein
the processor determines the discrepancy is detected when a number of times of consecutive transmission of a transmission-power control command for increasing transmission power of the mobile station exceeds a first threshold value or when a number of times of consecutive transmission of a transmission-power control command for decreasing transmission power of the mobile station exceeds a second threshold value.

4. The apparatus of claim 1, wherein
the processor transmits, to the mobile station, a signal for setting the second accumulated value held by the mobile station at a specified value, and changes the first accumulated value stored in the memory to the specified value.

5. The apparatus of claim 1, wherein
the processor transmits a start instruction signal of an uplink random access procedure to the mobile station.

6. The apparatus of claim 1, wherein
the processor periodically sets the first accumulated value held by the memory and the second accumulated value held by the mobile station at a predetermined value, in place of detecting the discrepancy or in addition to detecting the discrepancy.

7. The apparatus of claim 6, wherein
the processor transmits, to the mobile station, timing information indicating a timing at which the second accumulated value is to be set; and
the processor sets the first accumulated value held by the memory at the predetermined value, at the timing indicated by the timing information.

8. The apparatus of claim 1, wherein
the processor calculates a path loss between the mobile station and the apparatus; and
the processor transmits a first transmission-power control command to the mobile station when a change of the path loss is a threshold value or lower;
the processor transmits a second transmission-power control command to the mobile station when a change of the path loss is higher than the threshold value, wherein
the first transmission-power control command specifies an amount of relative change of transmission power of the mobile station, and the second transmission-power control command causes the mobile station:
to set the second accumulated value held by the mobile station at a specified value, and
to set transmission power of the mobile station in accordance with the specified value and the path loss between the mobile station and the apparatus.

9. A method for controlling transmission power of a mobile station, the method comprising:
holding, in a memory, a first accumulated value of a transmission-power control command that is transmitted to the mobile station so as to perform closed-loop control of transmission power of the mobile station;
detecting a discrepancy between the first accumulated value held by the memory and a second accumulated value of the transmission-power control command held by the mobile station; and
setting both the first accumulated value held by the memory and the second accumulated value held by the mobile station at a same value when the discrepancy is detected.
